(19) United States
(12) Patent Application Publication
(10) Pub. No.: US 2016/0267064 A1
(43) Pub. Date: Sep. 15, 2016

(54) Social Creation And Sharing Of Text Generators And Transformers II

(71) Applicant: Michelle Ran, Edison, NJ (US)

(72) Inventor: Michelle Ran, Edison, NJ (US)

(21) Appl. No.: 15/017,524

(22) Filed: Feb. 5, 2016

Related U.S. Application Data
(60) Provisional application No. 62/133,423, filed on Mar. 15, 2015.
(60) Provisional application No. 62/211,829, filed on Aug. 30, 2015.

(51) Int. Cl. G06F 17/22; G06F 3/0346; H04L 12/58; G06F 17/24; G06F 17/28; G06F 3/01; G06F 3/0488

(52) U.S. Cl. CPC G06F 17/2264; G06F 3/017; G06F 3/0346; G06F 3/04883; G06F 17/248; G06F 17/2872; H04L 51/02; H04L 51/046

(57) ABSTRACT

An social network system with messaging can facilitate socially creating and sharing of computer implemented text generators and transformers. Specifically, in an chatting app, users can create, share and apply text generators and transformers, apply them to a group of user inputs, to a conversation session, to a single message and to other specified user text inputs. Some particular implementation of text transformers and generators are discussed with socially created templates, word/phrase sets, transformation rules and randomization. Chaining and nesting of text generators and transformers can further empower social creation and sharing of text generators and transformers. Semiautomated chatting can be implemented with these text generators and transformers in a mobile device.

This application claim the benefit of U.S. Provisional Patent Application No. 62/133,423 filed on Mar. 15, 2015 and U.S. Provisional Patent Application No. 62/211,829 filed on Aug. 30, 2015

### FIELD OF INVENTION

This invention is related to social networking, chatting system, and text inputting automation, writing, sharing and community differentiation.

### BACKGROUND OF INVENTION

Text Inputting technology and automation, computer assisted creative writing, chatting and social networking, are separate technologies right now. The synergy between them is un-explored. Community differentiation and divergent language development and experimentation is a fundamental human demand that is ignored by technology development for now.

### SUMMARY OF THE INVENTION

In this system, we converge text chatting, and creation of text transformation and generation tools together to find a surprising synergy. Text transformers, text generators, and the components to create a text generators, such as text templates, word/phrase sets, transformation rules can all be socially created by ordinary users of the social network. They can be shared for users of this social network. They can also be promoted, taught through the use of them in text chatting.

Each text generators and transformers can be taken as a building block, together with components mentioned above, to form more sophisticated text transformers and generators by a process of chaining, analogical to function call chaining in mathematics. Randomization further give variation of generated text.

This system can facilitate and accelerate the experimentation of natural language, encourage divergent development of language and community differentiation from generic population.

Users who create, promote popular generators and transformers can be rewarded. These users are also most likely community leaders. A leader create his/her own language, or at least his/her own accent.

### DESCRIPTION OF FIGS.

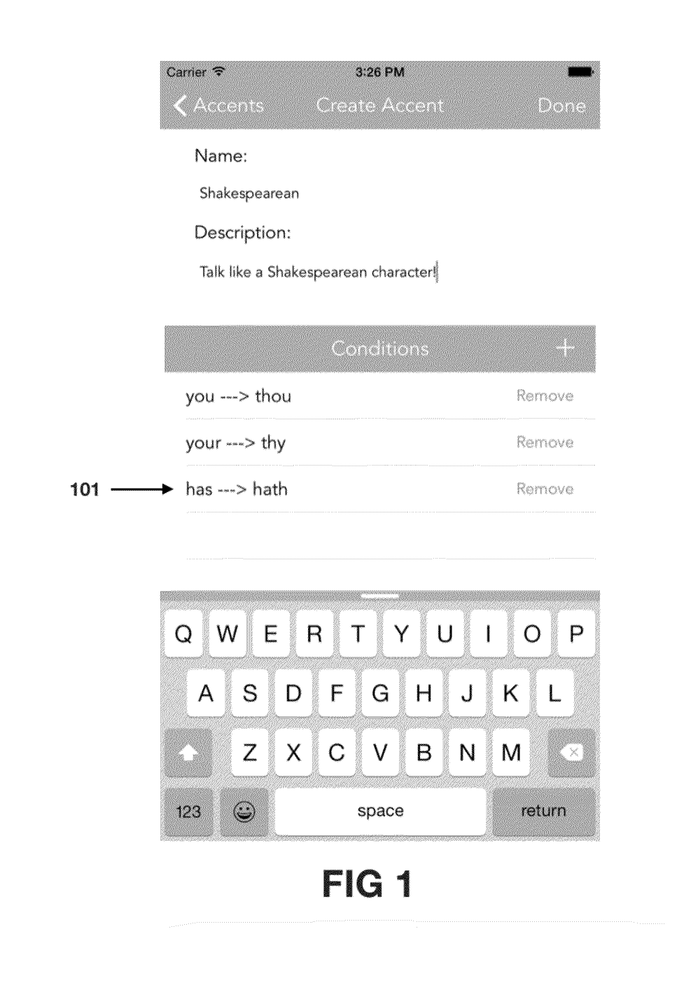

FIG. 1: A simple transformer creator screen. A transformer is called “accent” in this screen. This one is adding a transformation “has” to “hath” automatically in a transformer. Label 101 point to the transformation.

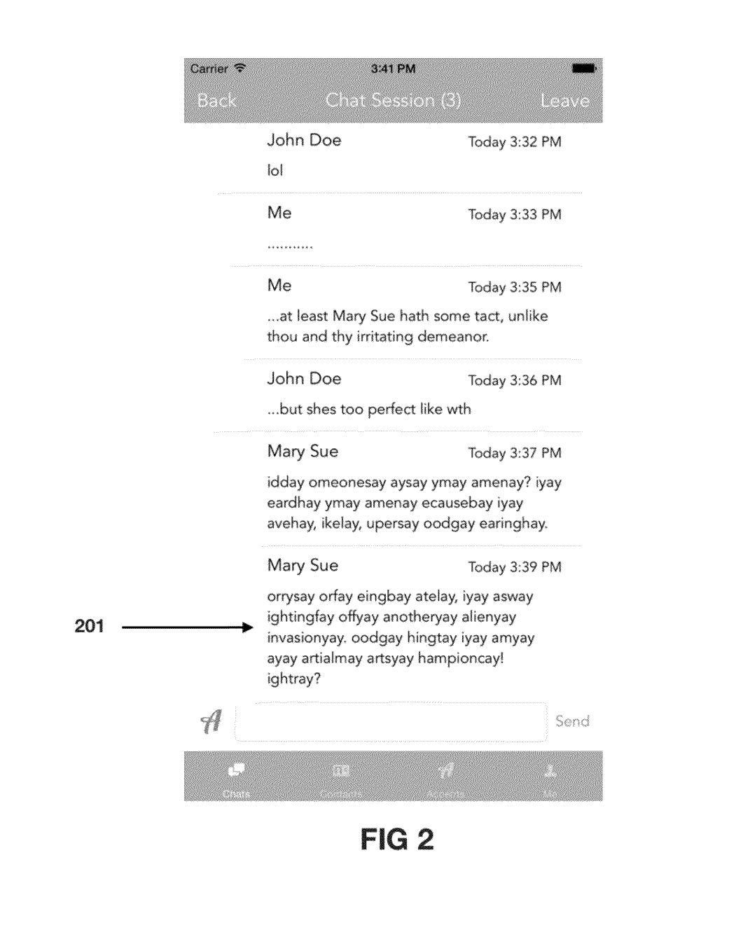

FIG. 2: A simple a chatting session screen, with transformers applied. The transformation is “Pig Latin”. 201 point to a transformed message.

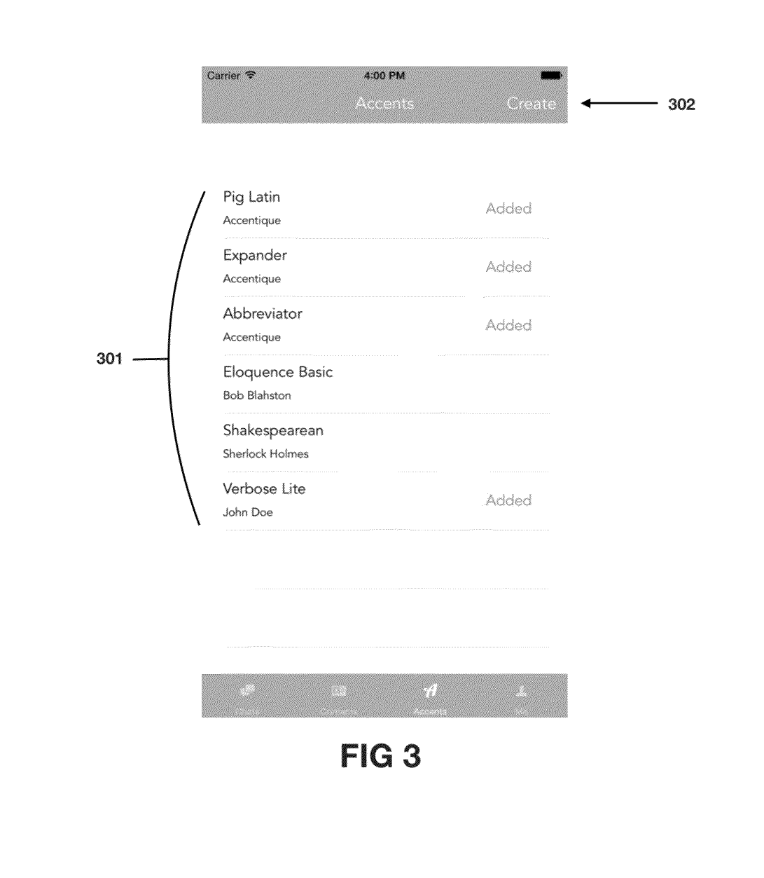

FIG. 3: A list of transformers, with the option to create more. Transformers are called “accents”. 301 is the list, 302 is the button to create more.

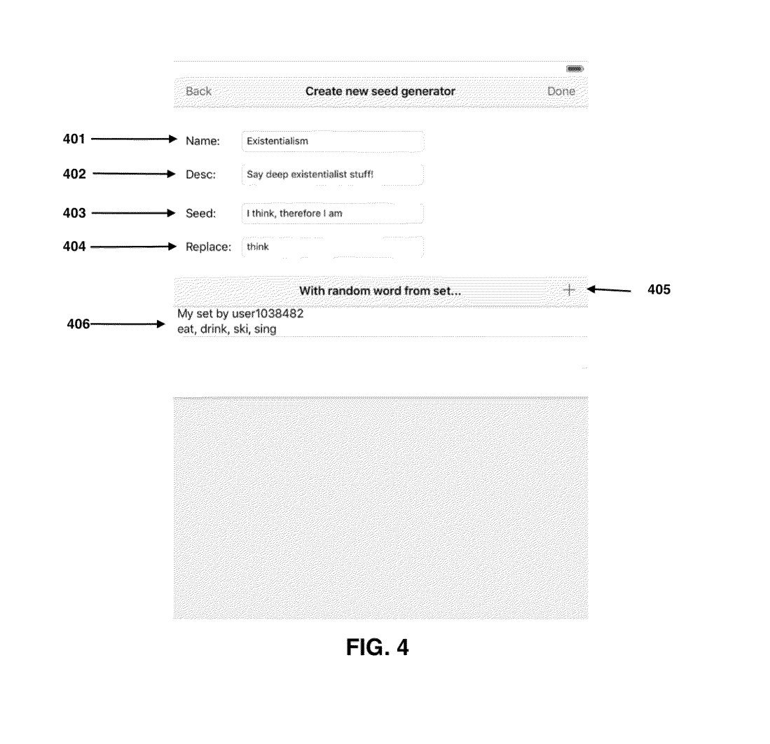

FIG. 4: A simple screen for generator creation. This type of generator begin with a template (called seed here), then replace a given word or phrase with a randomly selected word or phrases from a word/phrase set. The labels here are self evident.

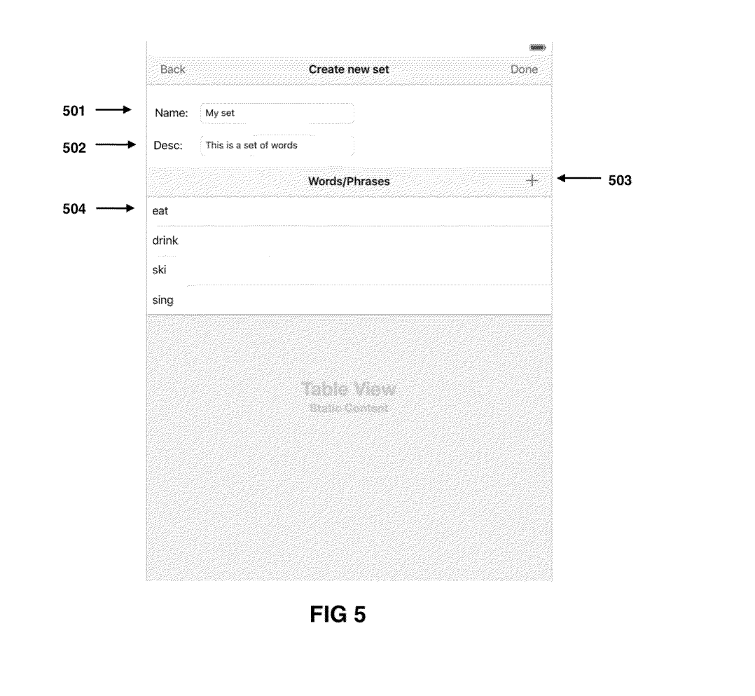

FIG. 5: A simple screen to create a word and phrase set, this set have a name/ID so it can be used by other components such as a text generator. 503 is the button to add more words/phrases.

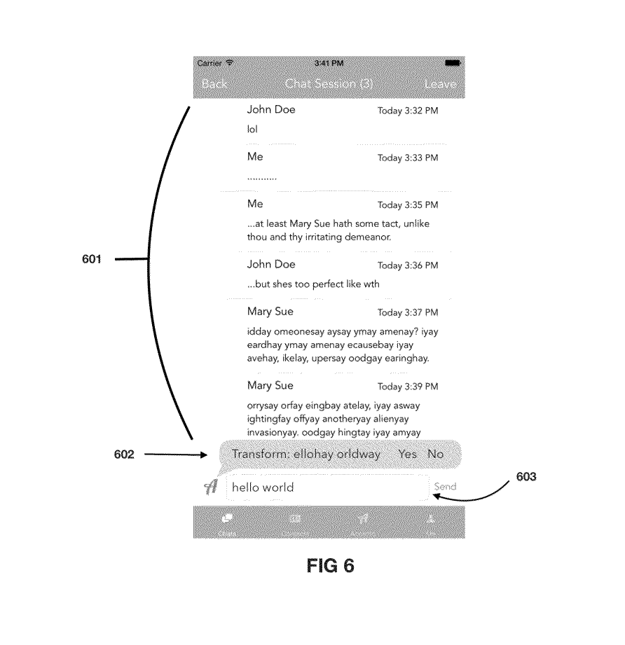

FIG. 6: a three text window system, top 601 is the chatting session window, middle 602 is messages transformed or generated by transformers and generators created socially, bottom 602 is the traditional text input window, including spelling correction etc. This is a “Pig Latin” transformation.

### DETAILS OF INVENTION

1: Text Generators and Transformers.

Inputting of text by human can be assisted by software. The most popular kind as of today, is software keyboard predict what a user want to type and correct common spelling mistakes.

In this applications, we explore this approach further to include text generators and transformers. Text generators can significantly speed up the creation of text information content. For example, a Haiku generator can automatically generate Haiku format poem. For generators to be interest, it can take some inputs and apply certain randomization. We are specially interested in a kind of text generators that take a text pattern as seed, apply replacement to part of this pattern from a randomized selection of a set of words/phrases. This seed can be a short sentence, a paragraph etc.

Transformers are very easy for users to create: one very simple implementation is to define a pattern, and transform the part of the input text that matches the defined pattern. Patterns can be defined by regular expression.

Transformers are similar to generators, but the differences are that transformers typically transform an input text into an output, with no dramatic size difference between input and output, or size difference is not important. Text generator may take some inputs from user (not creator of the generator), or may take no inputs. Text transformers must take inputs from user. Transformers are typically used to give text inputs an accent in this application.

We further emphasize these generators and transformers with randomization. We should have a reasonably large database of words, phrases, and patterns, and transformation rules. Then a generator/transformers can pick from some of these words, phrases, patterns randomly with some given constrain.

Some examples of transformers and generators can be: puns (transform or synthesize words with similar pronouncing words), parody (give a well known pattern, apply it in an dramatically different context).

In the claims, “computer implemented text transformer and generators” is claimed as one category in some claims, and then one particular implementation that can be more accurately named as “transformers” are claimed in dependent claims. Another implementation that can be more accurately named as “generators” are claimed in other dependent claims. There could be other transformers and generators that can not be classified easily as generators or transformers such as composite one that chain other transformers and generators.

Social Sharing of Text Generators and Transformers.

In this system we create tools to facilitate the creation and sharing of such text generators and transformers by common users in this social network. This way, we integrate the creation, sharing, applying, teaching and promoting of text generators and transformers in a seamless user experience of chatting with friends.

Once named or ID-ed, these generators and transformers are ready to be shared in an social network, and applied to messages and chatting sessions.

In an chatting application, users socialize with each other by typing text messages in real time to each other. Typing speed as well as quality of messages are very important in quality of communication. Generators can help in this situation to speed up the typing of text by generating patterned messages with user's inputs in it.

Transformers can help to give the text a personality, for example, transform words in the messages to a particular puns. All these are implementable in software. Generators and transformers can be shared in this chatting application. Users using the same transformers and generators feel connected because they share the same patterned languages and same accented language. These deviation from generic standard language foster divergent development distinguish a community from generic population. Community development is a fundamental goal for social networking. Divergent developing of communities create diversity in a population.

A text transformer and generator is only as good as how many users can actively use it. Like any tools, text generators and transformers need to be taught and promoted to be useful to users. Chatting app is the most effective channel to promote and teach these generators and transformers, and the best teacher is the creator him/herself who is also a friend in this social network chatting with you.

Through chaining, and the use of components such as word/phrase sets, seeding text templates, and transformation rules, a text generator and transformers can be created out of these components. Again, the social creation and sharing and teaching of these components are vey advantageous in facilitate the creating and use of ever more sophisticated text generators and transformers.

Seeding Text, Text Templates, Word and Phrase Sets

A text generators can take some inputs or not. There is a particular text generator implementation here is one, the creator put a text template as starting point, this template some time also called “seeding text”, or seed. Fort example, the seeding text can be “I think, therefore I am.”, then the generator replace “think” from a word randomly chosen from the set (eat, drink, ski, sing).

In this example, this set (eat, drink, ski, sing) can also be socially created. This system can just display a list based text input view, a user can just input a set of words, phrases, and given a name/ID for this set then save into the system for sharing. Other users can browse and search shared word/phrase sets, select some of these sets in creating text generators or transformers.

The seeding text or templates can also can be independently created by users, and shared with other users in the system. So everyone can use this shared templates to create more text generators.

Transformation rules can also be independently created and combined with independently created text templates, word/phrase sets to create new text generators, all created and shared socially.

Text patterns can be specified with well known technology such as regular expression. Randomization can be employed when pick one or more elements from a set such as world and phrase set.

Chaining or Nesting of Text Generators and Transformers

A text transformer can call upon other text transformers analogical to nested function calls in programming. For example, a text transformers can call upon three transformers. If one of the called transformers is itself, this is recursive call, there is a need to prevent infinite recursion. we can simply limit the depth of nesting to prevent such infinite recursion or other methods. Chaining or nesting can also be done with text generators. Chaining/nesting mechanism allows users build up transformers and generators by reuse each other's work, wonderful in a social networking system, so there is a very strong synergy to chain and nest text generators and transformers in a social networking system.

Community, Leadership and Rewarding

These who popularize certain transformers and generators are community builders. They are the natural leaders in a culture or sub culture. These leaders can be generically rewarded. But we can institutionalize such rewards to foster the emerging and growth of such leaders, especially in a young population such as teenagers and young adults. Such a chatting application therefore have build in leadership growth capability.

Semi Automatic Chatting.

There is an context in an chatting session, and the last message that need to be replied are obvious inputs to any parameterized generators and transformers. Plus randomization, a user can tap or click to automatically generate reply messages, tap or click or shake again, new message can be generated. This “tap again” can have an “tabu” like algorithm that try to differentiate from just generated messages. When user signal to the app a good one is generated, this good message can be send back as replay.

Within this chat app, the generators/transformed that use to generate or transform this message can be attached with the message (they can be or not be visible to the receiving user). Tap or click on the message, the same generator/transformers or related generator/transformers can be triggered to generate replay, again randomization, inputs from last messages and context, tabu algorithm can insure diversity of the generated message so the conversation can be non-robotic. The user has to accept the generated reply, may need to re-generate many replies before a user accept any.

This user can also type input words, then generator can generate full reply from one or a few input words. Again, re-generation, randomization and tabu algorithm can ensure generating enough diversity of reply, so to increase the chance of been accepted by user.

Long intervals in a conversation can be interpreted as negative feedback to an generated/transformed message, so generators and transformers can try to generate again with a tabu bias against rejected messages (rejection by long time interval).

Some Example Implementations:

Puns: user can specify certain pattern of letters to be transformed into other pattern which can be easily specified. by input patterns, output patterns. Pattern can be specified by literal letters combinations or by regular expressions among other methods.

Parody: From a well known text contents, replace certain part to generate new text.

Flavor: given a collection of words that are particular in Shakespeare's works, scan an input for any words that are synonym to the collected words, replace them with the collected words to give the text a Shakespeare flavor.

Positivity: scan an input for negative words, replace then with the positive equivalent. These positive equivalency mapping can be socially created.

Nesting or Channing: a text transformers and generators can call other text generators and transformers.

Meme: Memes are particular patterns of language usage. With text transformers and generators, memes can be automatically created and appeared in conversations.

Two Inputting Windows

Because of text transformers and text generators are broadly used in this system, we need at lease two display windows for user inputs: one is for normal inputs before applying a set of transformations, the other is for displaying transformed user message. The transformed message will be the one that finally been sent out if we accept the transformation and generation. Note the first window is the normal window we use today to do inputting may include typical autocompletion and spelling correction and other customized keyboard action. The second window is new to this system specifically exist to display transformed and generated messages because these operations are central to this system.

Together with chatting session display windows, we have three text display windows. They should be ranged in this order: user inputs before apply transformers and generators, generated or transformed messages, user chatting sessions, or exact inverse order. On a mobile phone, we prefer bottom to top: inputs before transformation, transformed inputs, chatting session. This order best represent user to chatting session message flow from keyboard to chatting session. In any situation, the new window is right at the middle that is very special to this system. There could be more windows to display more stages of transformation, two is least in this system.

There can be feed back to the transformed/generated messages from user. Positive or negative feedbacks, through touching of certain parts of the screen, or designated motion of mobile device when inputting using smart phones. For example, left right shaking indicating a negative feedback, to and fro nodding of the device indicating acceptance. And time lapse passing certain threshold after generation/transformation is a active chatting session indicating negative feedback, new transformation and generation can be attempted with tabu bias.

The System.

This way, a chatting app have build in tools, allows common users to create named generators and transformers. The chatting app then specifically facilitate sharing of these named generators and transformers with other common users. And users can then use these named generators and transformers in this chatting app to chat with other users. The seeds, transformation rules, word/phrase sets that are used in creating generators and transformers can also be socially generated and shared. These generators and transformers can be applied to messages, chatting sessions and user groups. Generators and transformers can be chained and nested. An extra window is created to facilitate these text transformation and generation. This is can have the potential to grow into a very large system, involving 1000, 10,000, 100,000, 1 million, 10 million or more users in the creation, sharing, of text generators and transformers and text seeds, and word/phrase sets. There can be 100; 1,000; 10,000; 100,000 transformers and generators.

Language and Terminology

Chatting App, Messenger App, Instant messaging system: These are all instances of computer implemented social networking system with messaging. They all have text messages intended for human consumption. So they all have users, and user can chat/messaging each other in near real time in the system. They are only different by name.

User: an social networking system must have users, and the system exist to serve these users. Users should be distinct from certain privileged users such as administrators and developers. Because the synergy of socially creating and sharing and using these text generators and transformers will be destroyed if only privileged users can participate. The broader the participation, the more the synergy.

Comments and Organization of Claims

//a text transformers creation tool implementation

1: a computing device implemented social networking system with messaging, to facilitate social creation and sharing of computing device implemented text transformers, the system comprising:

a rule capturing mean for users to input computing device implemented text transformation rules with rule name, a displaying and sharing mean for listing and sharing said created rules for users of said social networking system, a mean to apply selected set of said transformation rules to user inputs,

//apply to chatting sessions and user groups.

1.1: system in claim 1, said computing device implemented social network with messaging is a chatting app with chatting sessions, said system further comprising: a mean to designate said text transformers to be applied automatically to a chatting session,

1.2 system in claim 1, said computing device implemented social network with messaging has user groups, said system further comprising: a mean to designate said text transformers to be applied to a user group, whereby said text transformers can be applied automatically to chatting sessions for users in the group.

//chaining or nesting

1.3 system in claim 1, wherein said rule capture mean facilitates creating chained or nested text transformers.

//two windows

1.4 system in claim 1, said system further comprising: text display one and text display two, wherein text display one displays user inputs before applying text transformers, text display two display text after applying designated text transformers, whereby text display two content can be send to other users upon user commitment,

1.5 system in claim 1.4, wherein at least one of said designated text transformers is captured by said rule capturing mean,

1.6 system in claim 1.5, wherein said system have at least 100,000 users and 1,000 text transformers.

//two input windows, and chatting semi-automation

5: a computing device implemented social networking system with messaging, said system have text transformers, the system comprising: an inputting display mean one and an inputting display mean two, wherein said inputting display mean one displays user inputs before application of a set of transformations, said inputting display mean two displays inputs after application of said set of transformations, a mean to send said transformed inputs,

//transformers are socially created and shared

5.1 system in claim 5, wherein said text transformers are socially created and shared.

//with rejection

5.2 system in claim 5, the system further comprising: a mean for user to reject said transformed messages, whereby, said system can re-transform messages biased against rejected transformations,

//rejection implementation 1: timer

5.2.1 system in claim 5.2, said rejecting mean is an internal timer monitoring time lapse from message transformation, whereby, time lapse exceeding a designated threshold signals rejection,

//rejection implementation 2: motion

5.2.2 system in claim 5.2, wherein said system is running on a mobile communication device with self motion sensor, said rejection mean is a designated device motion,

//rejection implementation 3: touch

5.2.3, system in claim 5.2, wherein said system is running on a mobile communication device with touch screen, said rejection mean is a touch of designated region of said touch screen.

//a text generators creation tool implementation

10: a computing device implemented social networking system with messaging to facilitate social creation and sharing of computing device implemented text generators, said system comprising: a text input mean to collect user inputs of seeding text, a divergent transformation capturing means to collect rules to replace given patterns in said collected seeding text by randomized selection from a word and phrase set,

//socially create words and phrase sets

10.1 system in claim 10, said system further comprising: a mean to create and share a set of words and phrases by users, wherein said word and phrase set in claim 10 is created and shared by said mean,

//is a chatting app

10.2 system in claim 10, wherein said computing device implemented social network system with messaging is a chatting app.

//chaining or nesting, generators and transformers.

10.3 system in claim 10, said system further comprising: a mean to collect chained or nested text generators,

10.4 system in claim 10, said system further comprising: a mean to collect chained or nested text transformers,

//searchable by key words

10.5 system in claim 10, said system further comprising: a mean to collect key words for text generators, said text generators is searchable by key words and shared by users of said social network system.

//process claim, base

15 a method for socially creating and sharing computing device implemented text generators and transformers in a social networking system, said social networking system having text based conversation sessions, the method comprising: a) collecting text generators and transformers in a computing device implemented social networking system, b) sharing said collected text generators and text transformers to users of said social networking system, c) applying user selected text generators and text transformers to inputting messages to a text based conversation session,

//implementation of sharing

15.1 method in claim 15, wherein said text generators and transformers are named, said sharing of text generators and transformers comprising: displaying said named text generators and transformers to users of the said social networking system, facilitating selection by users on said displaying to be applied to inputting messages to designated text based conversation sessions.

//generator method implementation

15.2 method in claim 15, wherein said collecting socially created text generators comprising: collecting a text template, collecting a randomized replacement rule to replace designated text pattern in said text template with at least one randomly selected word or phrases from a word and phrase set,

//narrowing: word and phrase set is socially collected.

15.2.1 method in claim 15.2 wherein said word and phrase set is collected from users in a computer implemented social networking system.

//generator chaining or nesting

15.3 method in claim 15.2 wherein said computing device implemented text generators is chained or nested.

//transformer implementation

15.4 method in claim 15, wherein said collecting of computer implemented text transformers comprising: collecting at least one text pattern, collecting at least one transformation rule, wherein text can be transformed by applying said transformation rule onto text matched with said pattern,

//transformer chaining

15.4.1 method in claim 15.4, wherein said transformers are chained or nested.

//apply socially created generators for semi-automatic chatting on mobile phone.

15.5 method in claim 15 wherein said social networking system is an chatting app with mobile communication device terminals, said method further comprising: collecting an chatting session context, inputting said context into an parameter taking text generator, generating text messages, said generator is socially created,

//time interval re-generating

15.5.1 method in claim 15.5, said method further comprising: regenerating text message biased against previously generated un-send texts, after designated time interval without user send commitment command,

//touching re-generating

15.5.2, method in claim 15.5, wherein inputting is performed on a mobile communicating device with touch screen, said method further comprising: re-generating text message with biased against previous generated un-send messages upon tapping of an designated region of said touch screen,

//shaking re-generating

15.5.3 method in claim 15.5, wherein inputting is performed on an mobile communication device with shaking input method, said method further comprising: re-generating text message biased against previous generated un-send messages upon shaking of said mobile communication device.

What is claimed is:

1: a computing device implemented social networking system with messaging, to facilitate social creation and sharing of computing device implemented text transformers, the system comprising:
a rule capturing mean for users to input computing device implemented text transformation rules with rule name, a displaying and sharing mean for listing and sharing said captured rules for users of said social networking system, a mean to apply selected set of said transformation rules to user inputs,

2: system in claim 1, said computing device implemented social network with messaging is a chatting app with chatting sessions, said system further comprising:
a mean to designate said text transformers to be applied to inputs to a chatting session,

3: system in claim 1, said computing device implemented social network with messaging has user groups, said system further comprising: a mean to designate said text transformers to be applied to a user group, whereby said text transformers can be applied to chatting sessions for users in the group.

4: system in claim 1, wherein said rule capturing mean facilitates creating chained or nested text transformers.

5: system in claim 1, said system further comprising: text display one and text display two, wherein text display one displays user inputs before applying text transformers, text display two display text after applying designated text transformers, whereby text display two content can be send to other users upon user commitment,

6: system in claim 5, wherein at least one of said designated text transformers is captured by said rule capturing mean,

7: a computing device implemented social networking system with messaging, said system have text transformers, the system comprising: an inputting display mean one and an inputting display mean two, wherein said inputting display mean one displays user inputs before application of a set of transformations, said inputting display mean two displays inputs after application of said set of transformations, a mean to send said transformed inputs,

8: system in claim 7, wherein said text transformers are socially created and shared.

9: system in claim 7, the system further comprising: a mean for user to reject said transformed messages, whereby, said system can re-transform messages biased against rejected transformations,

10: system in claim 9, said rejecting mean is an internal timer monitoring time lapse from message transformation, whereby, time lapse exceeding a designated threshold signals rejection,

11: system in claim 9, wherein said system is running on a mobile communication device with self motion sensor, said rejection mean is a designated device motion,

12: system in claim 9, wherein said system is running on a mobile communication device with touch screen, said rejection mean is a touch of designated region of said touch screen.

13: system in claim 8, the system further comprising: a mean for user to reject said transformed messages, whereby, said system can re-transform messages biased against rejected transformations,

14: system in claim 13, said rejecting mean is an internal timer monitoring time lapse from message transformation, whereby, time lapse exceeding a designated threshold signals rejection,

15: system in claim 13, wherein said system is running on a mobile communication device with self motion sensor, said rejection mean is a designated device motion,

16: system in claim 7, said system have chatting session display mean and taking inputting from a mobile communication device, wherein layout of text input mean one, text input mean two and chatting session display mean is ordered from lower end upward,

17: a computing device implemented social networking system with messaging to facilitate social creation and sharing of computing device implemented text generators, said system comprising: a text input mean to collect user inputs of seeding text, a divergent transformation capturing means to collect rules to replace part of the seeding text matched with a given pattern by randomized selection from a word and phrase set,

18: system in claim 17, said system further comprising: a mean to create and share a set of words and phrases by users, wherein said word and phrase set in claim 10 is created and shared by said mean,

19: system in claim 17, wherein said computing device implemented social network system with messaging is a chatting app.

20: system in claim 17, said system further comprising: a mean to collect chained or nested text generators,

21: system in claim 17, said system further comprising: a mean to collect chained or nested text transformers,

22: system in claim 17, said system further comprising: a mean to collect key words for text generators, whereby said text generators is searchable by key words and sharable by users of said social network system.

23: a method for socially creating and sharing computing device implemented text generators and transformers in a social networking system, said social networking system having text based conversation sessions, the method comprising: a) collecting text generators and transformers in a computing device implemented social networking system, b) sharing said collected text generators and text transformers to users of said social networking system, c) applying user selected text generators and text transformers to inputting messages to a text based conversation session,

24: method in claim 23, wherein said text generators and transformers are named, said sharing of text generators and transformers comprising: displaying said named text generators and transformers to users of the said social networking system, facilitating selection by users on said displaying to be applied to inputting messages to designated text based conversation sessions.

25: method in claim 23, wherein said collecting socially created text generators comprising: collecting a text template, collecting a randomized replacement rule to replace designated text pattern in said text template with at least one randomly selected word or phrases from a word and phrase set,

26: method in claim 25 wherein said word and phrase set is collected from users in a computer implemented social networking system.

27: method in claim 25 wherein said computing device implemented text generators is chained or nested.

28: method in claim 23, wherein said collecting of computer implemented text transformers comprising: collecting at least one text pattern, collecting at least one transformation rule, wherein text can be transformed by applying said transformation rule onto text matched with said pattern,

29: method in claim 28, wherein said transformers are chained or nested.

30: method in claim 23, wherein said social networking system is an chatting app with mobile communication device terminals, said method further comprising:
collecting an chatting session context, inputting said context into an parameter taking text generator, generating text messages, said generator is socially created,

31: method in claim 30, said method further comprising: regenerating text message biased against previously generated un-send texts, after designated time interval without user send commitment command,

32: method in claim 30, wherein inputting is performed on a mobile communicating device with touch screen, said method further comprising: re-generating text message biased against previous generated un-send messages upon tapping of an designated region of said touch screen,

33: method in claim 30, wherein inputting is performed on an mobile communication device with shaking input method, said method further comprising: re-generating text message biased against previous generated un-send messages upon detecting shaking of said mobile communication device.
